(19) United States
(12) Patent Application Publication
(10) Pub. No.: US 2008/0209493 A1
(43) Pub. Date: Aug. 28, 2008

(54) Contents Browsing Apparatus And Method

(76) Inventors: Eun-Jeong Choi, Daejeon-city (KR); Jun-Seok Park, Daejeon-city (KR); Dong-Won Han, Daejeon-city (KR)

Correspondence Address: LADAS & PARRY LLP, 224 SOUTH MICHIGAN AVENUE, SUITE 1600, CHICAGO, IL, 60604, US

(21) Appl. No.: 11/719,776

(22) PCT Filed: Nov. 22, 2005
(86) PCT No.: PCT/KR05/03936

§ 371 Date: Oct. 11, 2007

(30) Foreign Application Priority Data
Nov. 22, 2004 (KR) 10-2004-0095904

(51) Int. Cl. H04N 7/173

(52) U.S. Cl. 725/119

(57) ABSTRACT

Provided are a content browsing apparatus and method. The method includes: generating a terminal profile which includes system information and a user profile which includes information regarding user-preferred contents; receiving broadcasting contents or Web contents based on the information regarding the user-preferred contents included in the user profile; and rendering received broadcasting contents or Web contents based on the terminal profile and the user profile. Therefore, user-preferred broadcasting contents or Web contents can be provided.

### TECHNICAL FIELD

The present invention relates to a content browsing apparatus and method, and more particularly, to an apparatus and method for providing broadcasting contents and Web contents according to a user's preference.

### BACKGROUND ART

The global TV-Anytime forum is an international standards group which was established in 1999 with an aim of providing customized digital broadcasting. The TV-Anytime forumaims to standardize a technology which allows users to efficiently select desired contents from a huge amount of broadcasting contents provided through a variety of channels at a desired time by utilizing a personal digital recorder (PDR).

Korean Patent Publication No. 2002-0067915 discloses an “Adaptive Method and Apparatus for Automatically Customizing Program Content Enhanced to Reflect User Preference.” The enhanced program content is triggered automatically or selectively according to a viewer profile. The user profile is a numeric expression of a user's interest in a plurality of attributes. The viewer profile is automatically adjusted based on whether a user accepts or rejects the enhanced program content. In other words, the viewer profile is automatically adjusted based on the user's reaction to the enhanced program content.

Korean Patent Laid-open Publication No. 2001-0105404 discloses an “Adaptive TV Program Recommender.” A system for recommending TV programs uses a statistics and a viewer profile to recommend a TV program.

The conventional apparatuses described above are types of TV program recommending systems that use metadata to produce contents. However, such conventional apparatuses cannot satisfy the needs of users who wish to view both TV broadcasting contents and Web contents.

### BRIEF DESCRIPTION OF THE DRAWINGS

The above and other features and advantages of the present invention will become more apparent by describing in detail exemplary embodiments thereof with reference to the attached drawings in which:

FIG. 1 is a block diagram of a contents browsing apparatus according to an embodiment of the present invention; and

FIG. 2 is a flowchart illustrating a contents browsing method according to an embodiment of the present invention.

### DETAILED DESCRIPTION OF THE INVENTION

### Technical Goal of the Invention

The present invention provides a contents browsing apparatus and method that provide broadcasting contents and Web contents according to a user's preference.

### Disclosure of the Invention

According to an aspect of the present invention, there is provided a contents browsing apparatus including: a profile management unit generating a terminal profile which comprises system information and a user profile which comprises information regarding user-preferred contents; a content reception processing unit receiving broadcasting contents or Web contents based on the information regarding the user-preferred contents included in the user profile; and a rendering engine unit rendering the received broadcasting contents or Web contents based on the terminal profile and the user profile.

According to another aspect of the present invention, there is provided a contents browsing method including: generating a terminal profile which comprises system information, and a user profile which comprises information regarding user-preferred contents; receiving broadcasting contents or Web contents based on the information regarding the user-preferred contents included in the user profile; and rendering received broadcasting contents or Web contents based on the terminal profile and the user profile.

### Effect of the Invention

A contents browsing apparatus according to the present invention does not need to simultaneously receive broadcasting contents and Web content. Instead, the apparatus can selectively receive the broadcasting contents or the Web contents according to a user's preference. In addition, the apparatus can provide contents desired by a user, reflecting the user's preference, and can provide contents by rendering a screen configuration according to a user's preference.

### BEST MODE FOR CARRYING OUT THE INVENTION

The present invention will now be described more fully with reference to the accompanying drawings, in which exemplary embodiments of the invention are shown. The invention may, however, be embodied in many different forms and should not be construed as being limited to the embodiments set forth therein; rather, these embodiments are provided so that this disclosure will be thorough and complete, and will fully convey the concept of the invention to those skilled in the art.

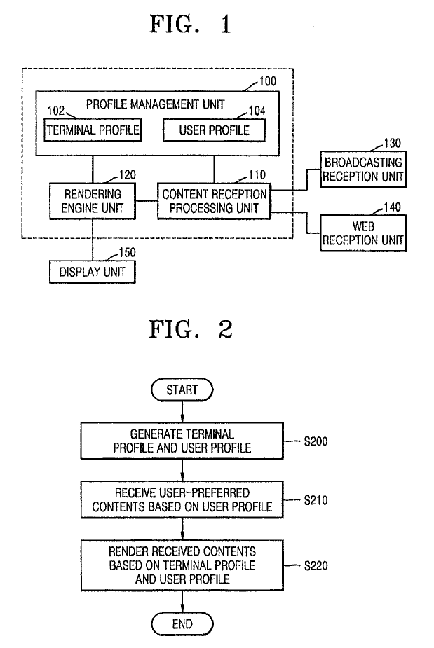

FIG. 1 is a block diagram of a contents browsing apparatus according to an embodiment of the present invention. Referring to FIG. 1, the contents browsing apparatus includes a profile management unit 100, a content reception processing unit 110, a rendering engine unit 120, a broadcasting reception unit 130, a web reception unit 140, and a display unit 150.

The profile management unit 100 generates and manages a terminal profile 102 which includes system information and a user profile 104 which includes information regarding user-preferred contents (hereinafter, referred to as user-preferred content information). A profile is composed of information regarding particular characteristics.

The terminal profile 102 includes system information such as data processing and storing capacity, types of processable contents, and screen size of the contents browsing apparatus according to the current embodiment of the present invention (hereinafter, referred to as a “terminal”). The user profile 104 includes information regarding a channel or a Web page (i.e., information regarding user-preferred contents) that a user wishes to view first when the terminal is turned on, user information (such as age, gender, job, and telephone number), the user's desired sound volume, a desired font size of a Web page, electronic transaction information (such as account number, credit card number, certificate related information, and address), and so on.

The terminal profile 102 is created only once by the vendor when manufacturing the terminal or by a user. When there are a plurality of users using the terminal, the user profile 104 is created for each user and stored in the terminal. In this case, the profile management unit 100 authenticates a user using a conventional user authentication method and uses the user profile 104 of the authenticated user.

The user profile 104 may be directly input by a user from the terminal or be downloaded from a predetermined server on the Internet. In other words, if the user profile 104 exists in a predetermined Internet server, the profile management unit 100 authenticates a user using an ID/password available in the terminal or using a user authentication apparatus such as iris recognition. Once the user is authenticated, the profile management unit 100 downloads the user profile 104 of the authenticated user from the server.

Information included in the user profile 104 may be modified directly by a user or may be automatically updated based on patterns in a user's selection of broadcasting channels or Web pages. For example, the profile management unit 100 identifies information regarding a broadcasting channel or a Web page most frequently viewed by a user at a particular time of the week and updates the user-preferred content information based on the identified information. The profile management unit 100 also identifies the user's desired viewing environment such as the sound volume of a broadcasting channel or the font size of a Web page and automatically updates the user profile 104 accordingly.

The content reception processing unit 110 receives broadcasting contents or Web contents based on user-preferred contents included in the user profile 104. Specifically, if the user-preferred contents are broadcasting contents, the content reception processing unit 110 accesses a server providing the broadcasting contents and receives the broadcasting contents. If the user-preferred contents are Web contents of a Web page, the content reception processing unit 110 accesses the Web page using a uniform resource locator(URL) address of the Web page and receives the Web contents.

If a web server providing the Web contents offers a content conversion function, the content reception processing unit 110 transmits the terminal profile 102 and the user profile 104 to the server that provides the Web contents and receives the Web contents converted according to the terminal profile 102 and the user profile 104 from the server.

The content reception processing unit 110 is connected to both the broadcasting reception unit 130 which receives broadcasting contents and the web reception unit 140 which receives Web contents. Hence, the content reception processing unit 110 can receive desired contents. For example, if user-preferred contents included in the user profile 104 are broadcasting contents, the content reception processing unit 110 receives predetermined broadcasting contents through the broadcasting reception unit 130. If the user-preferred contents included in the user profile 104 are Web contents, the contents reception processing unit 110 receives Web contents of a predetermined URL address through the web reception unit 140.

According to a conventional method of supporting Web-based digital broadcasting, Web data is included in a broadcasting carrier. For example, when a home shopping channel broadcasts a product, related information is included in a broadcasting carrier in the form of Web data. Therefore, when a user wishes to know detailed information regarding the product, the user can view the stored Web data through a Web browser by pressing a predetermined button. In this case, the Web data is transmitted to the user regardless of whether the user wants the Web data. According to the current embodiment of the present invention, the content reception processing unit 110 selectively accesses broadcasting contents or Web contents using the broadcasting reception unit 130 or the Web reception unit 140 based on user-preferred contents included in the user profile 104 and receives desired contents.

When the user-preferred contents included in the user profile 104 are not currently available, the content reception processing unit 110 provides contents, which were reserved and recorded in advance, according to a predetermined order of priority. To this end, the terminal according to the current embodiment of the present invention provides a function for recording contents at a reserved time selected by a user. Since reserved recording of broadcasting contents is a know technology in the art, a detailed description thereof will be omitted from this disclosure. The priority of recorded contents is determined according to a user's preference using a predetermined method.

When there are at least two contents corresponding to the user-preferred contents included in the user profile 104, the content reception processing unit 110 receives the at least two contents according to an order of priority and provides the received contents. For example, when both of broadcasting contents of a predetermined channel and Web contents of a predetermined Web page which correspond to the user-preferred contents included in the user profile 104 exist, the content reception processing unit 110 receives the Web contents first if it is determined that the Web contents have a higher priority than the broadcasting contents.

Alternatively, the content reception processing unit 110 may receive both the broadcasting contents and the Web contents and simultaneously display the broadcasting contents and the Web contents on a split screen.

When neither contents corresponding to the user-preferred contents included in the profile 104 nor pre-recorded contents are available, the content reception processing unit 110 provides broadcasting contents of a channel that a user viewed last.

The rendering engine unit 120 renders contents received by the content reception processing unit 110 according to a user's preference. Specifically, the rendering engine unit 120 converts the received contents according to a user's preference based on the system information included in the terminal profile 102 and information regarding, for example, the user's preferred sound volume and font size and provides the converted contents to the user.

For example, when the content reception processing unit 110 receives Web contents, the rendering engine unit 120 adjusts the font size of the received Web contents based on information regarding character size included in the user profile 104. In addition, when the Web contents are composed of a plurality of Web pages and a user wishes to view all of the Web pages, the rendering engine unit 120 divides the screen and renders the Web contents such that all of the Web pages can be simultaneously displayed on the split screen. Alternatively, the rendering engine unit 120 renders the received Web contents, which are overlaid, transparent on the screen for displaying broadcasting contents or divides the screen and simultaneously displays the received Web contents and the broadcasting contents on the split screen.

Generally, a page of Web contents are requested. However, when a page contains a lot of Web contents (including image, flash, and text), a screen must be scrolled if a display device is small. In particular, portable devices, such as mobile phones or personal digital assistants (PDAs), have limited interfaces as well as small screens. Thus, if general Web contents (such as Naver, Yahoo, and shopping malls) are included in one view, it is difficult for users to view the Web contents through the portable devices. TVs have larger screens than desktop PCs. However, since TVs must be watched from a predetermined distance, the font size has to be enlarged. In this case, the view of contents becomes larger which, in turn, forces users to scroll the view.

Therefore, the rendering engine unit 120 divides received contents into a plurality of sections according to the size of the view, connects the sections using a hyperlink, and displays the connected sections. In other words, the rendering engine unit 120 renders the entire Web page in one view according to a user's preference included in the user profile 104 (scrolling required) or divides the Web page into a plurality of sections to fit into the view (no scrolling required).

A method of dividing and displaying a Web page whose layout is larger than a screen window will now be described.

First, the terminal receives Web contents from a Web server. The terminal parses a Web page and creates a tree-like document object model. In this case, a node of the tree is composed of character string data, pictures, etc. The size of the layout of the Web page displayed on the screen is calculated. In other words, the size of the layout is calculated based on nodes such as elements, images, or texts. After the size of the layout of a node is calculated, it is determined whether the calculated size is larger than a predetermined size. If the calculated size is larger than the predetermined size, the Web page is divided into a plurality of pages. Then, an interface through which users can easily view the pages is provided using a hyperlink. Finally, a top page of the document object model is displayed on the screen.

The display unit 150 displays contents rendered by the rending engine unit 120 on a display device.

FIG. 2 is a flowchart illustrating a contents browsing method according to an embodiment of the present invention.

Referring to FIG. 2, a terminal profile which includes system information, and a user profile which includes user-preferred contents and information regarding a user's preferred sound volume and font size are created (operation S200). The user profile may be directly input by a user from a terminal or be downloaded from a predetermined server on the Internet.

Based on the user-preferred contents included in the user profile, contents that a user wishes to view first when the terminal is turned on are identified and the contents are received (operation S210). If the user-preferred contents are broadcasting contents, the broadcasting contents are downloaded by wire or wireless means from a server that provides the broadcasting contents. If the user-preferred contents are Web contents of a Web page, the Web page is accessed using a URL address of the Web page and the Web contents are downloaded.

The downloaded contents are rendered and displayed according to the system information included in the terminal profile and user-preferred screen configuration (such as font size, sound volume, and screen division) included in the user profile (operation S220).

The present invention can also be implemented as computer-readable code on a computer-readable recording medium. The computer-readable recording medium is any data storage device that can store data which can be thereafter read by a computer system. Examples of the computer-readable recording medium include read-only memory (ROM), random-access memory (RAM), CD-ROMs, magnetic tapes, floppy disks, optical data storage devices, and carrier waves (such as data transmission through the Internet).

The computer-readable recording medium can also be distributed over network-coupled computer systems so that the computer-readable code is stored and executed in a distributed fashion.

While the present invention has been particularly shown and described with reference to exemplary embodiments thereof, it will be understood by those of ordinary skill in the art that various changes in form and details may be made therein without departing from the spirit and scope of the present invention as defined by the following claims.

1. (canceled)

2. A contents browsing apparatus comprising:
a profile management unit generating a terminal profile which comprises system information and a user profile which comprises information regarding user-preferred contents;
a content reception processing unit receiving broadcasting contents or Web contents based on the information regarding the user-preferred contents included in the user profile; and
a rendering engine unit rendering the received broadcasting contents or Web contents based on the terminal profile and the user profile.

3. The apparatus of claim 2, wherein the system information constituting the terminal profile comprises screen resolution, data processing capacity and memory size, and the user profile comprises user information, information on a channel desired to be first displayed, or Web page information comprising the information regarding the user-preferred contents, font size, sound volume, and personal information for electronic transactions.

4. The apparatus of claim 2, wherein the profile management unit updates the information regarding the user-preferred contents based on information regarding a channel or a Web page most frequently selected by a user for a predetermined period of time.

5. The apparatus of claim 2, wherein the profile management unit receives the user profile from a predetermined server on the Internet.

6. The apparatus of claim 2, wherein the content reception processing unit receives broadcasting contents of a channel when the user-preferred contents included in the user profile are the broadcasting contents, and accesses a Web page using a URL address of the Web page and receives Web contents of the Web page when the user-preferred contents are the Web contents.

7. The apparatus of claim 6, wherein the content reception processing unit transmits the terminal profile and the user profile to a Web server which provides Web contents and receives Web contents properly converted based on the terminal profile and the user profile from the Web server.

8. The apparatus of claim 2, wherein the content reception processing unit provides pre-recorded contents according to an order of priority when contents corresponding to the user-preferred contents are not available.

9. The apparatus of claim 2, wherein, when a plurality of contents corresponding to the user-preferred contents exist, the content reception processing unit receives the contents according to the order of priority.

10. The apparatus of claim 2, wherein the rendering engine unit adjusts the sound volume or font size of the received broadcasting contents or Web contents based on the system information included in the terminal profile and the information regarding the user's preferred sound volume or font size included in the user profile.

11. The apparatus of claim 2, wherein the rendering engine unit divides the received Web contents into at least one section.

12. The apparatus of claim 2, wherein the rendering engine unit divides a screen and displays the received broadcasting contents or Web contents on a portion of the split screen.

13. The apparatus of claim 2, further comprising:
a broadcasting reception unit receiving broadcasting contents at a request of the content reception processing unit; and
a Web reception unit accessing a predetermined URL at the request of the content reception processing unit and receiving Web contents.

14. The apparatus of claim 2, further comprising a display unit displaying the rendered contents on the screen.

15. A contents browsing method comprising:
generating a terminal profile which comprises system information, and a user profile which comprises information regarding user-preferred contents;
receiving broadcasting contents or Web contents based on the information regarding the user-preferred contents included in the user profile; and
rendering received broadcasting contents or Web contents based on the terminal profile and the user profile.

16. The method of claim 15, wherein the generation of the terminal profile and the user profile comprises receiving the user profile directly from a user or from a predetermined server on the Internet.

17. The method of claim 15, wherein the reception of the broadcasting contents or the Web contents comprises providing pre-recorded contents according to an order of priority when contents corresponding to the user-preferred contents are not available.

18. The method of claim 15, wherein, when a plurality of contents corresponding to the user-preferred contents exist, the reception of the broadcasting contents or the Web contents comprises receiving the contents according to the order of priority.

19. The method of claim 15, wherein the reception of the broadcasting contents or the Web contents comprises receiving broadcasting contents of a channel when the user-preferred contents included in the user profile are the broadcasting contents, and accessing a Web page using a URL address of the Web page and receiving Web contents of the Web page when the user-preferred contents are the Web contents.
